(19) United States
(12) Patent Application Publication
(10) Pub. No.: US 2004/0048225 A1
(43) Pub. Date: Mar. 11, 2004

(54) Dental drill guide and method

(76) Inventor: Gayle J. Fletcher, Conroe, TX (US)

Correspondence Address: Alan J. Atkinson, P.O. Box 270161, Houston, TX, 77277-0161, US

(21) Appl. No.: 10/238,071

(22) Filed: Sep. 9, 2002

(51) Int. Cl. A61C 3/02

(52) U.S. Cl. 433/76

(57) ABSTRACT

An apparatus and method for guiding the formation of multiple, parallel holes in bone or implant in the mouth of a patient. A bar is engagable with a pivot and a slidable drill guide moves along the bar. Rotation of the bar about the pivot and radial movement of the drill guide relative to the bar permits selective positioning of the drill guide at different locations. The drill guide directs a drill bit to control hole formation of one or more holes parallel to the original reference. The angle, proximity and location of holes can be controlled.

### BACKGROUND OF THE INVENTION

The present invention relates to the field of dental surgery. More particularly, the invention relates to an apparatus and method for drilling parallel holes in a patient's jaw and other bone structures.

Dental systems require anchor devices for establishing a firm attachment to bone. Holes are drilled in the bone structure to facilitate attachment of the anchor devices. Such holes are typically drilled “freehand” wherein the dentist's visual observations solely provide position and alignment control. To verify placement and alignment of a drill bit, a dental technician or other assistant typically provides visual alignment confirmation from a different viewing angle. Free-hand drilling should be performed only be skilled and experienced dental surgeons. If the bone is not homogeneous, the drill can be deflected and create a deformed or oversized hole. The incorrect drilling trajectory can damage nearby structures such as the patient's alveolar nerve and can lead to implant failures.

In addition to free-hand drilling, other known practices include hole drilling through a prepared hole in a plastic matrix and hole drilling through a metal bushing supported by a plastic matrix. An acrylic resin mask is formed from the patient's dental arch so that the mask will fit over the patient's alveslar ridge. The correct position of the guide hole or cylinder is determined by an implantologist based on experience and with the assistance of a radiographic evaluation of the patient's jaw bone. After the template is made, however, the configuration of the resin mask and guide hole or cylinder is not easily moved.

Numerous systems have been developed to permit alignment of a single device. As representative examples, U.S. Pat. No. 4,832,601 to Linden (1989) disclosed an adjustable support for changing the orientation of a prosthetic tooth. U.S. Pat. No. 5,133,662 to Metcalfe (1992) disclosed an anchoring member and tooth support for removable positioning. U.S. Pat. No. 5,302,126 to Wimmer et al. (1994) disclosed an adjustable post for a dental implant system. U.S. Pat. No. 6,135,773 to Lazzara (2000) disclosed a single tooth alignment system using an orientation tool for aligning an implant.

Conventional dental practice assumes that two or more positioned pins will be nonparallel, and different techniques have been developed to align the attaching devices. Conventional “parallel” pins are manufactured and distributed with fifteen degree and twenty-five degree offsets to adjust for misaligned holes, confirming the expectation that multiple holes will be misaligned. As another example, U.S. Pat. No. 5,215,460 to Perry (1993) disclosed an alignment and fastening guide having articulated joints attachable to two nonparallel pins. A single jig provided for parallel alignment of the attached joints, and the joints were then glued into the aligned configuration. A different type of alignment guide was disclosed in U.S. Pat. No. 5,997,299 to Unger (1999), wherein a slotted guide facilitated placement of multiple devices each having an articulated joint for connection to the attached pins.

These systems addressed the misalignment of pins within a patient's bone structure after the holes had been drilled. Various techniques have been developed to guide the drilling of holes in bone. U.S. Pat. No. 5,055,042 to Jansen (1991) disclosed a dental drill and template for drilling a second hole parallel to a first hole. U.S. Pat. No. 5,320,529 to Pompa (1994) disclosed a technique to modeling a template for a jaw. U.S. Pat. No. 5,718,579 to Kennedy (1995) disclosed a drill guide kit having a cylindrical metal sleeve in a splint for receiving a rotatable dowel. To form the splint, a cast model was formed of the patient's dentition. U.S. Pat. No. 5,636,986 to Pezeshkian (1997) disclosed a drill guide system having guides configured in the shape of teeth. U.S. Pat. No. 5,800,168 to Cascione et al. (1998) disclosed a dental implant guide formed with a radio opaque material having a cylindrical housing and guide cylinders with different sizes. U.S. Pat. No. 5,989,025 to Conley (1999) disclosed a drill guide having a tubular body with a screw thread and stent for removable attachment.

Other techniques attempted to align multiple drill holes before placement of the pins. U.S. Pat. No. 5,842,859 to Palacci (1998) disclosed a bearing member having a free end for indicating placement of another hole. U.S. Pat. No. 5,888,065 to Sussman (1999) disclosed a jaw for attachment to one tooth and having an aperture for guiding drilling of an adjacent hole. U.S. Pat. No. 5,954,769 to Rosenlicht (1999) disclosed a string of drill bodies attached to one or more positioning bars. The drill body position was fixed along the positioning bars, and the positioning bar was deformable to permit movement of the drill bodies in two dimensions. Although the drill bodies permitted parallel drilling of multiple holes, the distance between holes was not easily adjusted. Additionally, the system required substantial bulk to be positioned within a patient's mouth. Such bulk encumbered drilling and other dental operations and increased discomfort to the patient. U.S. Pat. No. 5,967,777 to Klein et al. (1999) disclosed a computer aided template and drilling system.

A need exists for an improved apparatus and method for directing a drill bit. The device should easily fit within a patient's mouth and should accurately and efficiently direct placement of parallel holes in the patient's bone.

### SUMMARY OF THE INVENTION

The invention provides an apparatus and method for directing a drill bit to form a hole in the bone of a patient. The apparatus comprises a pivot attachable to a first hole in the bone and having an axis, a bar pivotable about the pivot for rotation about the pivot in a plane substantially perpendicular to the pivot axis, and a guide slidably engaged with the bar to permit adjustment of the distance between the guide and the pivot, wherein the guide is formed to direct the drill bit in a direction substantially parallel to said pivot axis.

The method of the invention comprises the steps of placing a pivot having an axis in a first hole formed within the bone, engaging a bar with the pivot, wherein the bar is slidably engaged with a guide for directing the drill bit in a selected direction parallel to the pivot axis, moving the guide into a selected location relative to the bone by rotating the bar relative to the pivot in a plane substantially parallel to the pivot axis and by moving the guide relative to the bar, and operating the drill bit in cooperation with the guide to drill a second hole in a location directed by the guide, wherein the second hole is substantially parallel to said pivot axis.

### BRIEF DESCRIPTION OF THE DRAWINGS

FIG. 1 illustrates an elevation view of the invention oriented relative to the lower jaw of a patient.

FIG. 2 illustrates a plan view of a bar and engaged guide.

FIG. 3 illustrates a side view of a bar and engaged guide.

FIG. 4 illustrates another embodiment of the invention wherein a bar and integrated guide are slidable relative to a pin.

### DESCRIPTION OF THE PREFERRED EMBODIMENTS

The invention provides a novel apparatus and method for drilling parallel holes in bone. Holes are accurately aligned to avoid the discomfort and liability associated with improper alignment. The invention is particularly useful in the field of dentistry wherein access to the patient's bone structure is confined, and wherein significant forces are exerted on pins and other devices mounted to the bone.

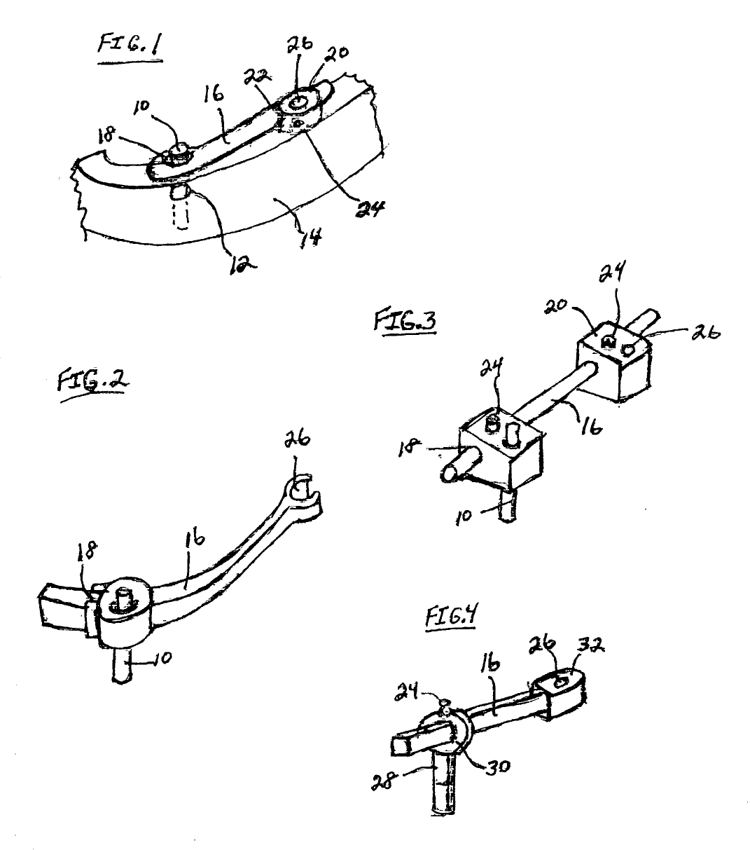

FIG. 1 illustrates one embodiment of the invention wherein a pivot such as pin 10 is installed in hole 12 formed in bone structure 14. Pin 10 has a longitudinal pivot axis as shown which functions as a pivot point. Bar 16 is pivotably engaged with pin 10 for rotation about pin 10 in a plane substantially perpendicular to the pivot axis. In one embodiment of the invention, such pivotable engagement is provided by inserting aperture 18 within bar 16 over an upper, exposed end of pin 10. Although bar 16 is illustrated as a substantially linear member, bar 16 can be curved, formed with one or more pieces or sections, and can have numerous configurations and shapes. The cross-section of bar 16 can be rectangular, circular, elliptical, formed with two or more members, irregular, or formed in other shapes.

Guide 20 can be slidably engaged with bar 16 for adjusting the distance between the pivot axis and guide 20. The slidable engagement between bar 16 and guide 20 can be accomplished in many different ways and is shown in FIG. 1 as comprising an aperture 22 through which bar 16 is inserted. If desired, lock 24 in the form of a set screw or other mechanical device can selectively connect guide 20 to bar 16. Guide 20 can be moved inwardly or outwardly relative to pin 10 by moving guide 20 relative to bar 16, by moving bar 16 relative to pin 10 as discussed below, or combination of both.

Guide 20 can be shaped or formed in different ways to direct the path of a drill bit into the patient's bone. This function can be accomplished by an aperture 26 as shown in FIG. 1 or can be accomplished by a shoulder, surface, protrusions, or other modified form integral within or attached to guide 20. Aperture 26 can be lined with a hard faced material such as metal or can accommodate a bushing attachment integrated with or independent from a drill. FIGS. 2 and 3 show alternative view of these components and possible configurations for the moving components.

FIG. 4 illustrates another embodiment of the invention wherein pin 28 includes aperture 30 for slidable engagement with bar 16. Distal end 32 provides the function provided by guide 20 in FIG. 1, and can comprise a separate component or can be integrated within bar 16. Lock 24 can selectively retain bar 16 in a fixed position relative to pin 28.

Operation of the inventive method can be accomplished in several different ways. In one method, pin 10 is temporarily or permanently set within hole 12 and bar 16 is pivotably engaged with pin 10. Guide 20 is slidably moved along bar 16 so that the pivotable movement of bar 16 and the sliding movement of guide 20 cooperates to reach a selected position adjacent the bone. Because such movement occurs in a plane substantially perpendicular to the pivot axis through pin 10, subsequent operation of a drill bit relative to guide 20 generates a second hole substantially parallel to the first hole and pin 10. Proper orientation of guide 20 relative to pin 10 axis controls the axial orientation of the resulting holes in a parallel or selectively nonparallel orientation.

In various embodiments of the invention lock 24 can be operated to retain guide 20 in a fixed location relative to bar 16. In another embodiment of the invention using the embodiment shown in FIG. 4, rotation of bar 16 and radial movement of bar 16 and attached distal end 32 relative to pin 28 provides selective control for positioning the second hole in the bone. Lock 24 can lock the movement of bar axially relative to pin 10, and can also lock the rotation of bar 16 relative to pin 10 in another embodiment of the invention.

After the second hole is drilled, the apparatus can be unlocked or otherwise operated in a similar fashion to drill a third hole in the bone parallel to the first and second holes. In this fashion multiple parallel holes can be drilled without the alignment errors customary in conventional practice.

The device is compact, contains few components, and is especially suited for the narrow confines within a patient's mouth in dental practice. The apparatus can operate from a pin such as pin 10 previously set within the patient's bone or can be used as a template to guide the angle of the first hole before pin 10 is set. In dentistry, the apparatus is equally adaptable to either side of a patient's mouth, and to the upper and lower bone structures within a patient's mouth. The invention can be attached to existing implants or other structures within the patient's mouth. As used herein references to forming a hole in the bone of a patient are equally to the act and process of forming a hole in an existing implant or other structure within the patient's mouth. One innovative benefit of the invention provides the same consistent anchor in bone, implant, or other stable structure within the mouth. These features of the invention minimize the work within the mouth and provide less trauma to patients. Although the invention is particularly suited for the narrow confines within a patient's mouth, the invention is application to the drilling of parallel holes in other bone structures.

All components can be manufactured from metal, plastic, composite materials, or other compounds to provide the operating functions. Components can be disposable to meet sterility requirements or can be designed to be sterilized with conventional techniques applicable to the dental, medical and veterinary professions.

Although the invention has been described in terms of certain preferred embodiments, it will become apparent to those of ordinary skill in the art that modifications and improvements can be made to the inventive concepts herein without departing from the scope of the invention. The embodiments shown herein are merely illustrative of the inventive concepts and should not be interpreted as limiting the scope of the invention.

What is claimed is:

1. A guide for directing a drill bit to form a hole in the mouth of a patient, comprising:
a pivot attachable to a first hole and having an axis;
a bar pivotable about said pivot for rotation about said pivot in a plane substantially perpendicular to said pivot axis; and
a guide slidably engaged with said bar to permit adjustment of the distance between said guide and said pivot, wherein said guide is formed to direct the drill bit in a direction substantially parallel to said pivot axis.

2. A guide as recited in claim 1, further comprising an aperture through said guide for directing the drill bit in said parallel direction.

3. A guide as recited in claim 1, wherein said pivot is attached to said bar.

4. A guide as recited in claim 1, wherein said bar is rectangular in cross-section.

5. A guide as recited in claim 1, further comprising a lock for retaining said guide is a selected position relative to said bar.

6. A guide as recited in claim 1, wherein said bar is axially moveable relative to said pivot.

7. A guide as recited in claim 6, further comprising a lock for retaining said bar in a selected position relative to said pivot.

8. A guide as recited in claim 1, wherein said bar comprises a substantially linear member.

9. A guide as recited in claim 1, wherein said bar is curved.

10. A system for directing a drill bit to form at least two parallel holes in the bone of a patient, comprising:
a pivot having an axis and being attachable to a first hole formed in the bone by the drill bit;
a bar pivotably engaged with said pivot for rotation about said pivot in a plane substantially perpendicular to said pivot axis;
a guide moveably engaged with said bar to permit adjustment of the distance between said guide and said pivot, wherein said guide includes an aperture for directing the drill bit in a direction substantially parallel to said pivot axis.

11. A system as recited in claim 10, wherein said bar is formed to direct the drill bit in a selected direction to create the first hole for attachment by said pivot.

12. A system as recited in claim 10, wherein said pivot is attached to said bar.

13. A system as recited in claim 12, further comprising a lock for retaining said guide in a selected position relative to said bar.

14. A system as recited in claim 12, wherein said bar is axially moveable relative to said pivot.

15. A system as recited in claim 14, further comprising a lock for retaining said bar in a selected position relative to said pivot.

16. A method for directing a drill bit to form a hole in the bone of a patient, comprising the steps of:
placing a pivot having an axis in a first hole formed within the bone;
engaging a bar with said pivot, wherein said bar is slidably engaged with a guide for directing the drill bit in a selected direction parallel to said pivot axis;
moving said guide into a selected location relative to the bone by rotating said bar relative to said pivot in a plane substantially parallel to said pivot axis and by moving said guide relative to said bar; and
operating the drill bit in cooperation with said guide to drill a second hole in a location directed by said guide, wherein said second hole is substantially parallel to said pivot axis.

17. A method as recited in claim 16, further comprising the step of locking the guide relative to said bar before the drill bit is operated.

18. A method as recited in claim 16, further comprising the step of rotating said bar axially about said bar to vary the relative angle between said guide and said pivot axis.

19. A method as recited in claim 16, further comprising the step of operating the drill bit in cooperation with said pivot to drill the first hole.

20. A method as recited in claim 16, further comprising the steps of moving said guide into another selected location relative to the bone by rotating said bar relative to said pivot in a plane substantially parallel to said pivot axis and by moving said guide relative to said bar, and of operating the drill bit in cooperation with said guide to drill a third hole in the bone substantially parallel to said pivot axis and to said second hole.
